(19) United States
(12) Patent Application Publication
(10) Pub. No.: US 2014/0030755 A1
(43) Pub. Date: Jan. 30, 2014

(54) MICROPLATE FOR CORRELATIVE MICROSCOPY

(71) Applicant: University College Cardiff Consultants Limited, Cardiff (GB)

(72) Inventors: Chris John Allender, Cardiff (GB); Edward John Sayers, Maidenhead (GB); Arwyn Tomos Jones, Cardiff (GB); David Barrow, Cardiff (GB)

(73) Assignee: University College Cardiff Consultants Limited, Cardiff (GB)

(21) Appl. No.: 14/016,495

(22) Filed: Sep. 3, 2013

Related U.S. Application Data
(63) Continuation-in-part of application No. PCT/GB2012/050363, filed on Feb. 17, 2012.

(30) Foreign Application Priority Data
Mar. 4, 2011 (GB) 1103665.4

(51) Int. Cl. G01N 21/17

(52) U.S. Cl. CPC G01N 21/17
USPC 435/29; 422/552; 435/288.4

(57) ABSTRACT

The invention relates to a novel multiwell array comprising a plurality of wells, the majority of which have a unique cross-sectional shape whereby each well within the array can be identified and so tracked whilst the contents of the array are investigated. The invention also concerns a computer and a programmable data storage device for use with the array and an imaging apparatus including any one or more of the afore features or aspects.

This application is a continuation-in-part of international patent application no. PCT/GB2012/050363 filed on Feb. 17, 2012, which in turn claims priority from British Patent Application Ser. No. 1103665.4 filed on Mar. 4, 2011, the disclosures of which are incorporated herein by reference in their entirety.

### TECHNICAL FIELD OF THE INVENTION

The invention relates to novel wells or chambers, particularly, but not exclusively, for containing or isolating at least one cell for microscopy purposes; a method for the identification of wells within a multiwell array; a computer for identifying wells within a multiwell array wherein said computer is provided with a program for undertaking the afore method; a programmable data storage device comprising the afore method; an imaging apparatus comprising said computer and/or said data storage device; a method for the manufacture of said wells or chambers and a method of performing microscopy, including but not limited to correlative bright filed, fluorescence or electron microscopy using said wells or chambers.

### BACKGROUND OF THE INVENTION

Within any population of cells there is heterogeneity. Measured as a population, scientists can gather data on the trends of cell responses to various stimuli. There is a need, however, for tracking and analysing what happens to small groups of cells or individual cells. Live cell microscopy enables one to follow a few cells over time allowing high quality imaging typically using fluorescent conjugates as probes[1]. However, due to the wavelength and properties of light, structural resolution is low. To obtain greater structural detail, different microscopes are needed. High quality light microscopes, like the newly designed N-STORM (Nikon's STochastic Optical Reconstruction Microscopy) [2], can start to provide this detail but it is currently more common to use an electron microscope. There are two main classes of electron microscope, the scanning electron microscopy (SEM) for cell surface/topography imaging and transmission electron microscopy (TEM) for higher ultra-structural detail. It does, however, remain difficult to image the same group of cells or a single cell using different microscopic techniques due to the different preparatory steps needed for the different techniques. Imaging under light microscopes allows one to perform live cell imaging, for example, tracking the cellular effects of agents such as drugs or monitoring the cell dynamics of proteins expressing Green Fluorescent proteins. For this technique, cells need to be kept in an environment that sustains their viability (temperature, pH, media etc). Moreover, this technique also requires an optically clear, non-fluorescent substrate on which to image the cells. In contrast, electron microscopy requires cells to be fixed and subsequently dehydrated in order for them to be imaged under a vacuum.

It follows that one of the goals in microscopy is imaging the same group of cells or a single cell using different microscopic techniques such as, without limitation, those listed in Table 1. Being able to image the same group of cells or a single cell using multiple techniques enables researchers to correlate information from one imaging technique with that from another—correlative microscopy[3]. Thus, performing this sort of correlative microscopy researchers can gather more information on a group of cells or a single cell.

An implicit pre-requisite for correlative microscopy is retention and identification of a cells position during imaging. Various methods have been developed for this purpose including those that use the following: optical tweezers[4], both positive and negative dielectrophoresis[5] and microfluidic traps [6]. However, methods employing the use of microwells are by far the most common due to the ease with which microwells can be manufactured and used [7]. Microwells have been developed in various shapes and sizes but the most common shapes are either round or square-sectioned wells, typically provided in an array. These microwells have been used for a wide variety of purposes, including testing a B-cell array against an antigen[8] to look at how the shape of wells can be used to control stem cell growth [9]. Almost all microwells are made of one of two materials, glass or polydimethylsiloxane (PDMS), again due to the ease of manufacture[10]. Glass microwells need machining using a laser which makes them more expensive, PDMS is usually therefore used as a less expensive alternative. PDMS consists of a two part polymer which can be heat cured into the required shape. Typically a photoresist epoxy (SU-8) is used to create a positive of the shape required, and this mould can then be used repetitively to form a final PDMS.

At the moment there are few ways to achieve correlative microscopy. One of the ways, developed by Verkade et al 2008 [11] is to grow cells on a surface marked with a grid then perform live cell imaging of cells before using high pressure freezing to prepare the cells for electron analysis. Whilst, using this technique, researchers have been able to obtain good correlative images of endosome fusion, specialist equipment has been required to gain these images.

We have developed an alternative method for performing correlative microscopy that is suitable for both adherent and non-adherent cell types. Moreover, our method is straightforward to use and offers considerable diversity in terms of identification. Further, it can be used safely and easily with multiple imaging techniques such as those listed, by way of example only, in Table 1.

### SUMMARY OF THE INVENTION

According to a first aspect of the invention there is provided a multiwell array comprising a plurality of wells wherein each well comprises:
(a) a unique cross-sectional shape comprising at least one projection and/or indentation; and
(b) a universal projection or indentation in the same position on each well so as to indicate a standard orientation or reference point for taking a reading of the number, nature and position of each projection and/or indentation on a selected well as one works about the well, typically, in a clockwise or ant-clockwise manner.

In a further preferred embodiment of the invention each well is provided with a unique non-random cross-sectional shape. More preferably still, said unique non-random cross-sectional shape is provided along a substantial part of the depth or height of the well and, ideally, along the entire depth or height of the well.

In a further preferred embodiment of the invention each well is provided with a unique cross-sectional shape having regard to the alignment of each well with respect to a selected axis, thus wells of the same cross-sectional shape may be rotated with respect to said axis so as to provide different shapes when viewed from a fixed point.

Additionally, or alternatively, each well is provided with a common cell accomodating region from which at least one projection protrudes and/or into which at least one indentation indents to thus give each well its unique crossectional shape. Preferably each well comprises a plurality of projections and/or indentations. Ideally the shape and/or position of said projection(s) and/or indentation(s) with respect to the common cell accomodating region is different between different wells. Thus, where a plurality of projections and/or indentations are provided their shape and/or position with respect to the common cell accomodating region is different between different wells.

Typically, the common cell accomodating region is generally of round or square section and it is from this region or into this region that the projection(s) and/or indentation(s) project or indent, respectively. However, other sections may be used, such as triangular, pentagonal, hexagonal, heptagonal, octagonal, nonagonal or any other polygonal shape.

More typically still, the projections or indentations are either curved so that they appear as a bump or angular so that they appear as a pointed projection.

In yet a further preferred embodiment, said cell accomodating region comprises an internal chamber, which is fixed within the well or removable therefrom. Ideally, said internal chamber is of the same shape and/or size between wells and is generally of round or square cross-section. As will be appreciated by those skilled in the art, said internal chamber can be used, for example but not limited to, cell culture wherein the same cross-sectional size and shape standardises culture conditions between each well in isolation of the unique cross-sectional shape of each respective well. Alternatively, said internal chambers may each be of a different size and/or shape according to the users requirements.

In yet a further preferred embodiment of the invention, the universal projection or indentation is a projection or indentation of the same size and shape between wells.

It will be apparent to those skilled in the art that the designation of the shape of a well can be made using any suitable nomenclature. For example, using a numeric code, projections may be given a selected odd number depending on their size and/or shape whereas indentations may be given a selected even number depending on their size and/or shape. Further, gaps or spaces between projections or indentations may be given a 0 designation. Thus the projection of say a universal marker at 12 o clock is designated 1 for each well; an adjacent space or rather uninterrupted continuence of the circular or square-sectional cell accomodating region of the well is designated as 0; alternatively, the provision of a second projection adjacent to said universal marker is designated as a selected odd number depending on its shape and size, e.g. 3. Thus a first well having the universal marker followed by a space is 10 and a second well having the universal marker followed by a second projection is 13 or 15 or 17 (depending upon the odd no. identity of the second projection). A third well having the universal marker followed by an indentation is marked as 12. A fourth well having the universal marker followed by a second projection followed by a space followed by an indentation is 1102, and so on. The complexity, and so diversity, of the naming system may also specify the size of spaces between projections or indentations by using a different 0 designation, for e.g. 0¹, 0², 0³ etc., for a selected number of degrees of rotation about the well.

Alternatively still, a binary system of nomenclature may be preferred where, e.g., the projection of say a universal marker at 12 o clock, using a binary code, is designated 1 for each well; an adjacent space or rather uninterrupted continuence of the circular or square-sectional nature of the well is marked as 0. The provision of a second adjacent projection is marked as 11. Thus a first well having the universal marker followed by a space is 10 and a second well having the universal marker followed by a second projection is 111. A third well having the universal marker followed by an indentation is marked as 1111. A fourth well having the universal marker followed by a second projection followed by a space followed by an indention is 1110111, and so on.

It follows from the above that different projections and indentations are given different nomenclature/numbers according to their shape and size with respect to the edge or boundary of each cell accomodating region of each well.

Moreover, as one reads about the perimeter of each well one recites either a number corresponding to the shape and size of a projection/indentation or a number representative of a space between projections/indentations; i.e. representative of the uninterrupted continuence of the circular or square-sectional nature of the cell accomodating region of each well.

Although the invention has been described having regard to a numeric identification or coding system, other suitable systems may be used e.g. alphabetical systems such as the Roman, Arabic or Cyrillic systems. Alternatively, the invention may be worked having regard to logographic script. Those skilled in the art will appreciate that any suitable means may be provided for designating the cross-sectional shape of each well.

Using the above, each well within a multiwell array is therefore given its own code or name, dependent upon its shape, having regard to a reading taken from a common universal marker. This means that an exact well can be indentified between different imaging techniques.

Moreover, we prefer to make our multiwell arrays/wells from a synthetic plastics so that cells within wells can be fixed, stained and then sectioned and each section of each well will retain its characteristic cross-sectional shape thus facilitating the identification of sections and so the correlating of cell sections with previously named wells. In this way, live cell imaging can be correlated with cell sections revealing ultra-structural information.

In yet a further preferred embodiment of the invention at least one of said projections or indentations decreases in size along the depth or height of the well; in other words it is funnel shaped. This feature is preferred because it enables one to estimate where within the depth or height of the well each cell is located or each section is taken.

Additionally, or in an alternative aspect, the position of each well within the array with respect to the position of other adjacent wells, or wells along the same axis, may be used to identify or name each well. For example wells may be spaced differently with respect to neighbouring wells by predetermined amounts and this spacing may serve to identify one well from another or each well form a selected axis or marker.

In yet a further preferred embodiment of the invention said arrays are microarrays.

According to a further aspect of the invention there is provided a method for the identification of wells within a multiwell array comprising:
a) selecting a point from which to begin reading the outer cross-sectional shape of each well within said array by identifying the location of a universal indicator common to all the wells;
b) designating each projection or indentation with its unique identifier, having regard to its size and shape, as a reading is taken from said selected point about the edge of each well;
c) designating each space between projections and/or indentations with its identifier as a reading is taken about the edge of each well; and
d) using the nature, order and number of identifiers designated as a reading is taken about the edge of each well to provide each well with a unique identification code that enables each well to be identified within an array and tracked thereafter.

In a preferred method of the invention said space between projections and/or indentations is also provided with a unique identifier having regard to its size and position from said selected point.

Typically, but not exclusively, the wells within the multiwell array are microwells and the array is a microarray.

Those skilled in the art will appreciate that, typically, designating each projection, indentation or space in the above method occurs successively as one traces a path about the perimeter of each well, however, it is within the scope of the invention to designate groups of identifiers as one traces a path about the perimeter of each well. For example, all the projections may be designated as one traces a path about the perimeter of each well, followed by either all the spaces or all the indentations. Permeatations on how the identifiers are read fall within the scope of the invention, provided one is consistent about how each reading is taken between individual wells, and more particularly, all the individual wells with a multiwell array.

In yet a further aspect of the invention there is provided a computer for identifying wells within a multiwell array wherein said computer is provided with a program for undertaking the afore method.

In yet another aspect, the invention provides a programmable data storage device comprising the afore method.

In yet another aspect, in, or for use in, an imaging apparatus there is provided a computer or data storage device as afore described.

In yet a still further aspect the invention provides a method for the manufacture of a multiwell array comprising:
a) providing a mask of a multiwell array wherein said mask includes a plurality of wells having different cross-sectional shapes, at least when viewed from a fixed point;
b) ablating a selected material to provide an image of said mask;
c) agitating and cleaning said image to provide the final multiwell array.

In a preferred method, said mask is made from a metal sheet and said ablating is under taken by laser machining Preferably still, the said material is a plastics material such as PDMS or an epoxy resin but in any case is a material that is sectionable using microscopic sectioning tools. More preferably again, said agitating is undertaken by sonication and, ideally, said cleaning involves washing or rinsing with water and/or alcohol.

In yet a further aspect said invention provides a method of performing correlative microscopy including, but not limited to, the examples shown in Table 1 such as correlative bright filed, fluorescence or electron microscopy using said microwell array.

Any of the afore aspects of the invention may, in preferred embodiments, include or be characterised by any of the aforementioned features pertaining to the multiwell.

In the claims which follow and in the preceding description of the invention, except where the context requires otherwise due to express language or necessary implication, the word “comprises”, or variations such as “comprised” or “comprising” is used in an inclusive sense i.e. to specify the presence of the stated features but not to preclude the presence or addition of further features in various embodiments of the invention.

All references, including any patent or patent application, cited in this specification are hereby incorporated by reference. No admission is made that any reference constitutes prior art. Further, no admission is made that any of the prior art constitutes part of the common general knowledge in the art.

Preferred features of each aspect of the invention may be as described in connection with any of the other aspects.

Other features of the present invention will become apparent from the following examples. Generally speaking, the invention extends to any novel one, or any novel combination, of the features disclosed in this specification (including the accompanying claims and drawings). Thus, features, integers, characteristics, compounds or chemical moieties described in conjunction with a particular aspect, embodiment or example of the invention are to be understood to be applicable to any other aspect, embodiment or example described herein, unless incompatible therewith.

Moreover, unless stated otherwise, any feature disclosed herein may be replaced by an alternative feature serving the same or a similar purpose.

### BRIEF DESCRIPTION OF THE DRAWINGS

The invention will now be described by way of example only with reference to the following figures, wherein:

FIG. 1 shows designs for a cover slip holder 1a, lower section 1b, and upper section 1c;

FIG. 2 shows: left hand side, round wells are embedded as a block in epoxy resin, middle, the resin is sectioned into layers, right hand side, a typical section of wells obtained from sectioning of round wells (a) and encoded wells (b);

FIG. 3 shows: spatially encoded wells, where each well is unique due to its distance from nearest neighbour in the x and y direction;

FIG. 4 shows: examples of alternative well designs, semi-circles/triangles on a square (a), semicircles around a star shaped hexagon with a mini semicircle for alignment (b), semi-circles based in a pentagon/hexagon shape with directional triangle (c and d);

FIG. 5 shows: an example of a binary encoded well bump system with direction finder indicated as the triangular projection at 12 o clock;

FIG. 6 shows: live cell images of KG1a leukaemic cells 1 hr after adding a pro-apoptotic (cytotoxic) peptide (left) and control peptide (right). Dead cells are labelled red with the dye propidium iodide, as indicated by the dashed circle;

FIGS. 7a, b & c show: K562 leukaemic cells resting in an encoded well 102 (a), KG1a cells resting in a round microwell (b and c); and

FIG. 8 shows: Correlative microscopy showing live KG1a cells under light microscopy (left) and the same cells viewed using scanning electron microscopy (right).

FIG. 9 shows: PDMS surfaces modified with APTES and DMDES. Cervical cancer HeLa cells have been allowed to grow on the surface before fixation and imaging. Actin and the nuclei have been stained;

FIG. 10 shows: 1 μm ultramicrotome section of coded microwell array in 301-2 and araldite. Arrow points to the direction triangle on the microwell; and

FIG. 11 shows: Preparation of encoded microwells in epoxy from glass originals.

### DETAILED DESCRIPTION OF THE INVENTION

### Materials & Methods

### Materials

PDMS (Sylgard 184) was obtained from Dow Corning, Platinic acid catalyst, divinylPDMS (DMS-V01). and dimethyldiethoxysilane (DMDES) was purchased from Fluorochem. Polymethylhydrosiloxane (M_{w} 1,700-3,200), potassium hydroxide, paraformaldehyde (PFA), Araldite 506, hexamethyldisilazane (HMDS), triethoxysilane (TEOS), propidium iodide (PI), Hoechst 33342, rhodamine phalloidin and aminopropryltriethoxysilane (APTES) were obtained from Sigma-Aldrich (UK) Black liquid ink whiteboard (Easyflo, Pentel) was purchased from WH Smiths. Ethanol and methanol were purchased from Fisher scientific (UK). Epoxy resin 301-2 (ExoTech, USA) was obtained from JP Kummer (UK). Cell culture medias D-MEM and RPMI, foetal bovine serum (FBS, heat shocked for 30 minutes at 56° C. before being filtered using a 1.2 μm filter) and penicillin/streptomycin supplied by Invitrogen (UK).

### Microwell Fabrication

PDMS was mixed in a ratio of 10:1 prepolymer to curing agent and cast on a coverslip either 150-170 μm thick or to a glass plus coverslip thickness of 200 μm. The polymer was degassed for 30 mins by placing in a vacuum before being baked at 110° C. for 1 hr and allowed to cool.

Laser machining was performed in two separate ways. Firstly, glass or PDMS cover slips were coated in whiteboard ink. For circular wells, wells of 15 nm or 20 μm, were ablated into glass or PDMS individually using a 157 nm F₂ eximer laser). For encoded microwells, first a mask was made for the microwell design in a metal sheet using 795 nm Ti:Sa femtosecond laser. The wells were then manufactured by ablating the coated glass or PDMS under a 192 nm laser containing the mask. After ablation the samples were cleaned up by sonicating for 20 mins in methanol, ethanol, 50% ethanol/distilled water and distilled water. Glass cover slips were further cleaned by wet etching in 7M KOH for 1 hour followed by washes in distilled water.

### Moulding

A positive mould of the glass cover slips with the wells was made using PDMS. Cover slips were placed under vacuum and the standard PDMS polymer mix was added. The vacuum was removed and sample degassed and baked as above. The cover slips were removed from the PDMS leaving a positive mould for the resin. Epoxy resin was made by mixing the prepolymers 11:8.7:0.3 Araldite 506: epoxy hardener: epoxy accelerator or 100:35 part A: part B (301-2). The polymer was then poured onto the PDMS mould allowing 35 μl of resin for each cover slip (this allows for a thickness approximately 160 μm, similar to a No. 0 glass cover slip). The resin was degassed in a vacuum for 30 minutes before being baked at 60° C. overnight for Araldite or 80° C. for three hours using 301-2 and allowed to cool (see FIG. 11).

### Chemical Modification

The hydrophobic PDMS surface was modified to make the surface more hydrophilic. First the PDMS was placed under UV/ozone for 90 minutes to create hydroxyl groups on the surface. The surface was immediately immersed in distilled water to maintain the groups. The surface was then immersed in 5 mM APTES, 5 mM TEOS solution or water for 2 hours at room temperature. These surfaces were subsequently cleaned by sonicating in ethanol and water (twice) for five minutes and backed in a drying oven overnight. The surfaces were subsequently stored in methanol (APTES) or water (PDMS, TEOS or hydroxyl-modified).

### Cell Preparation

Surfaces were sterilised by immersing the cover slips in ethanol for ten minutes followed by three five minute washes in sterile phosphate buffered saline (PBS). Adherent cells were plated onto the cover slips resting in 12 well plates at 100,000-200,000 cells per well and allowed to adhere overnight in complete media (D-MEM, 10% FBS and 100 U/ml penicillin with 100 μg/ml streptomycin). Before imaging, the cover slips were washed thrice in sterile PBS and placed in imaging media (RPMI medium lacking phenol red, containing 10% FBS and 10 μM Na-HEPES buffer pH 7.4). Non-adherent cells were plated directly onto the coverslip after washing. 1-2 ml of cells were removed from the culture flask and centrifuged at 800×g for 1 min in a microcentrifuge, the sample was resuspended in clear serum free media and washed a further two times. Finally the cells were resuspended in imaging medium at 500,000 per ml.

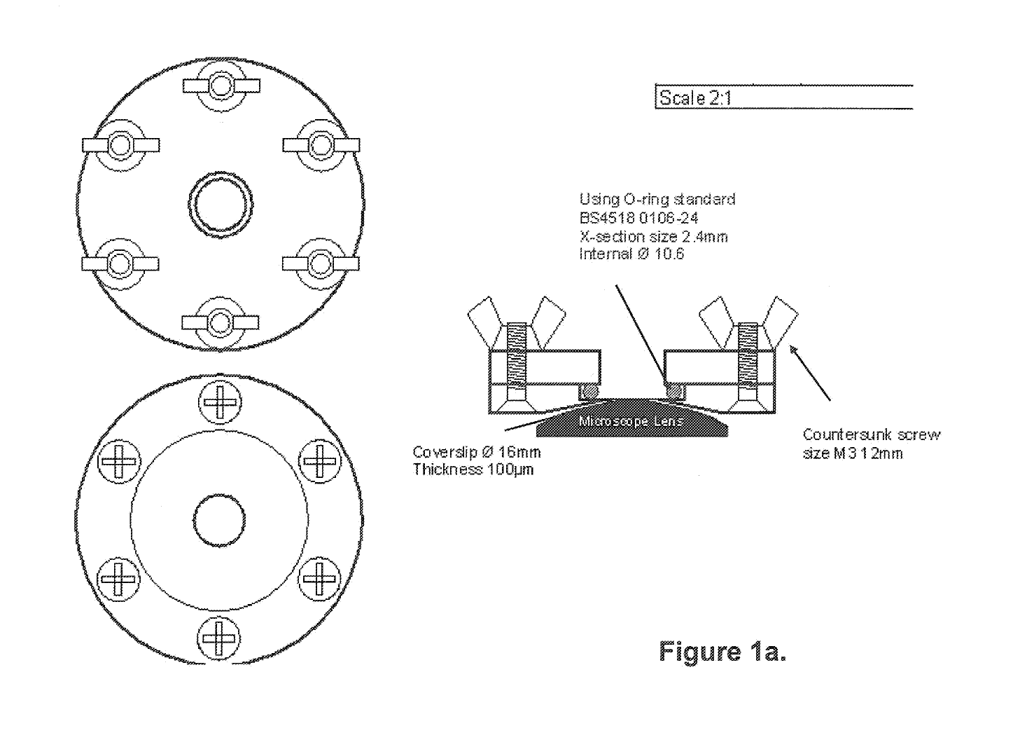

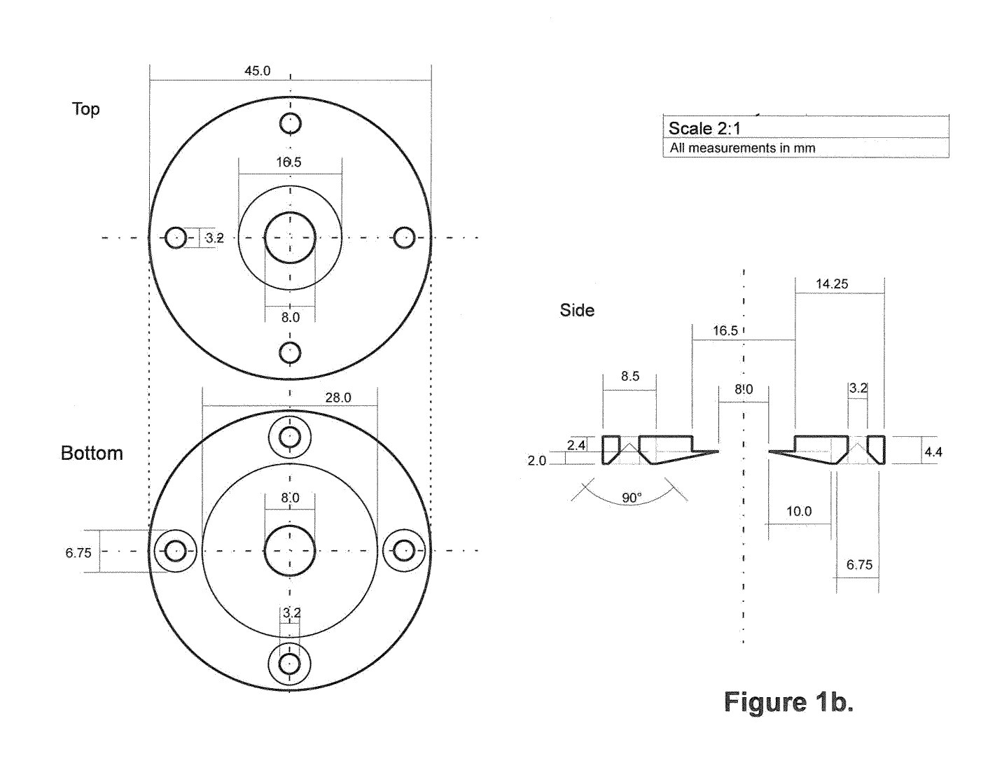

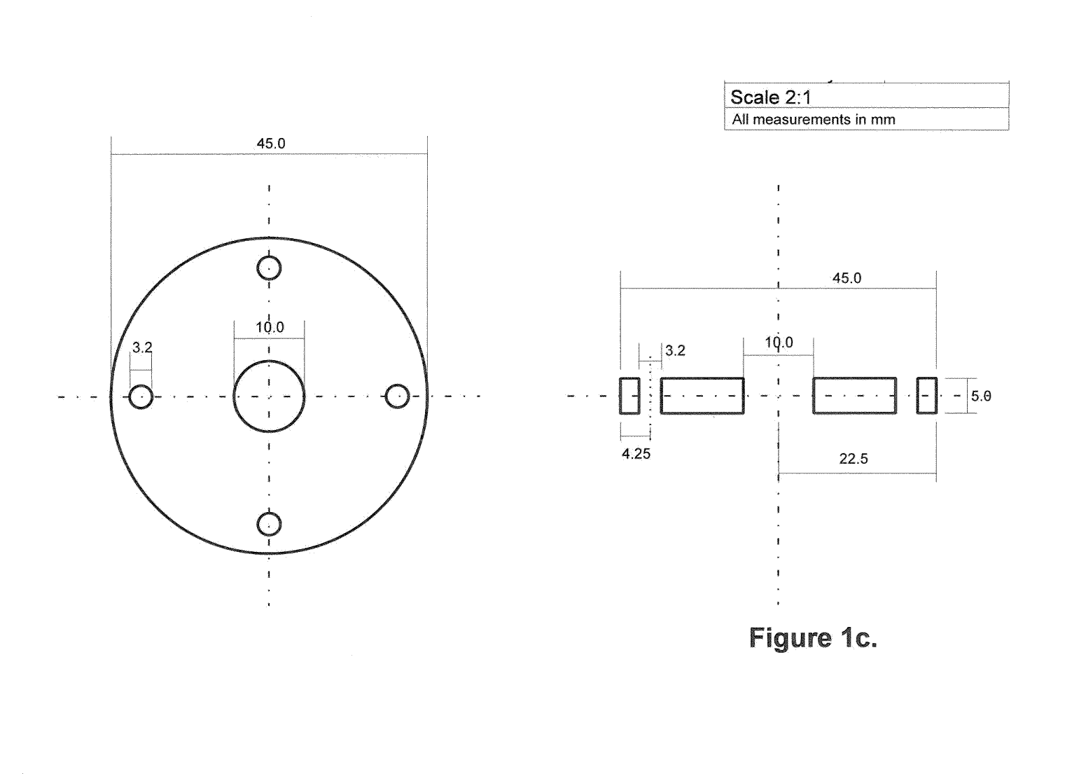

Cover slips were ideally held in place using a custom-made cover slip holder (see FIG. 1).

### Confocal Imaging

Cells were imaged live and fixed under the confocal microscope. For live cells, cells were imaged in imaging media at 37° C. during uptake of alexa488 or alexa633 labelled transferrin or after exposure to a pro-apoptotic CPP with 1 μg/ml propidium iodide (PI) added to the sample. For fixed cells, cells were fixed in 2% paraformaldehyde (PFA) in PBS for 15 minutes, washed in PBS and permeabilised in 0.02% triton for 10 mins. The cells are washed once and incubated with 0.2 μg/ml of Hoescht33342 and 1 μg/ml rhodamine-phalloidin for ten minutes. Cells are washed then mounted on a coverslip.

### SEM Imaging

Live cells were fixed in 1% glutaraldehyde for 30 minutes washed and post-fixed in 1% osmium tetroxide for a further 30 minutes. Cells were washed and dehydrated in 10 min steps of 50%, 70%, 80%, 90% and three neat ethanol washes. The cells were dried either in CO₂ using a critical point drier or using hexamethyldisilazane (HMDS), whereby cells were washed twice in HMDS and allowed to air-dry in a fume hood. The cover slips were splutter-coated in gold and imaged using an SEM.

### Sectioning

PDMS was made using different ratios of short chained divinylPDMS with PDMS prepolymer. These mixes were added with a curing agent at a ratio of 1:1 with the short chained PDMS and 1:10 with the long chained PDMS. Platinic acid was added to the mix at 1 ul of 20 mg/ml (in THF) to 100 mg short chained divinylPDMS. The different mixes were degassed in a vacuum for 30 minutes and baked at 110° C. for 1 hour and allowed to cool as before. Pieces of PDMS were super-glued onto a mounting block for the microtome and attempts were made to section the material at different thicknesses.

Different ratios of the epoxy 301-2 were used ranging from 100:10 to 100:70 (part A:part B, part A being diglycidyl ether of Bisphenol A and part B being polyoxypropylenediamine) in steps of 10 and cured as before. This produced a range of epoxies of different hardness which were then sectioned on an ultramicrotome using a glass knife at two thicknesses 1 μm and 100 nm. Microwells were moulded of 301-2 as above at a ratio of 100:20 and were backfilled with and hardened as before. The microwell containing epoxies were again sectioned on an ultramicrotome using a glass knife.

### Results

### Design of Microwells

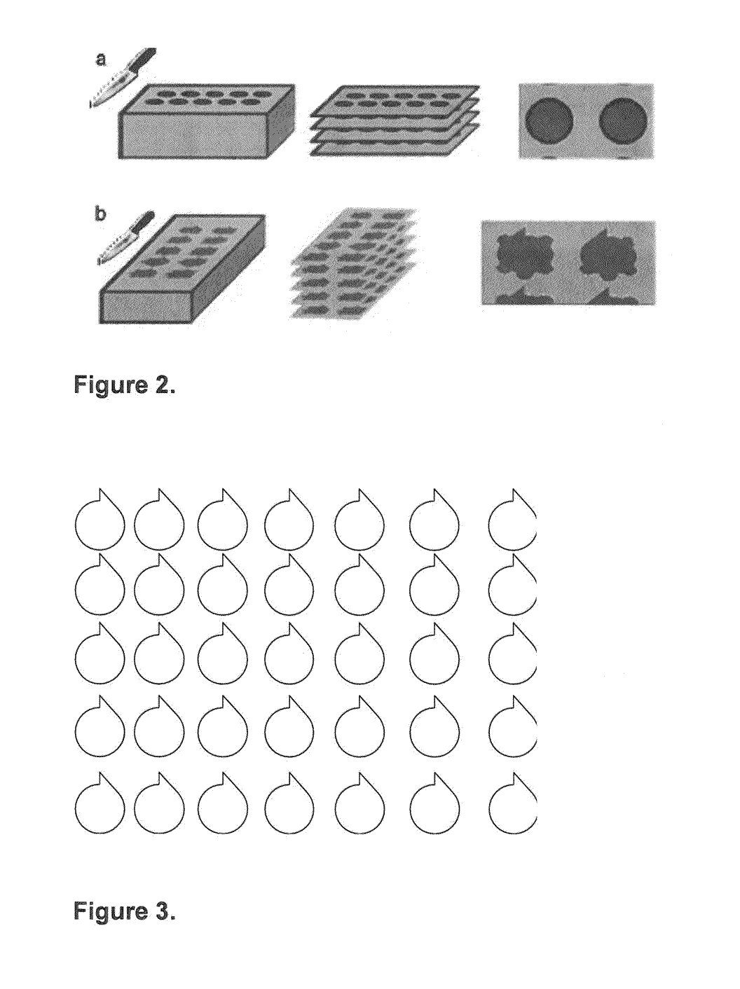

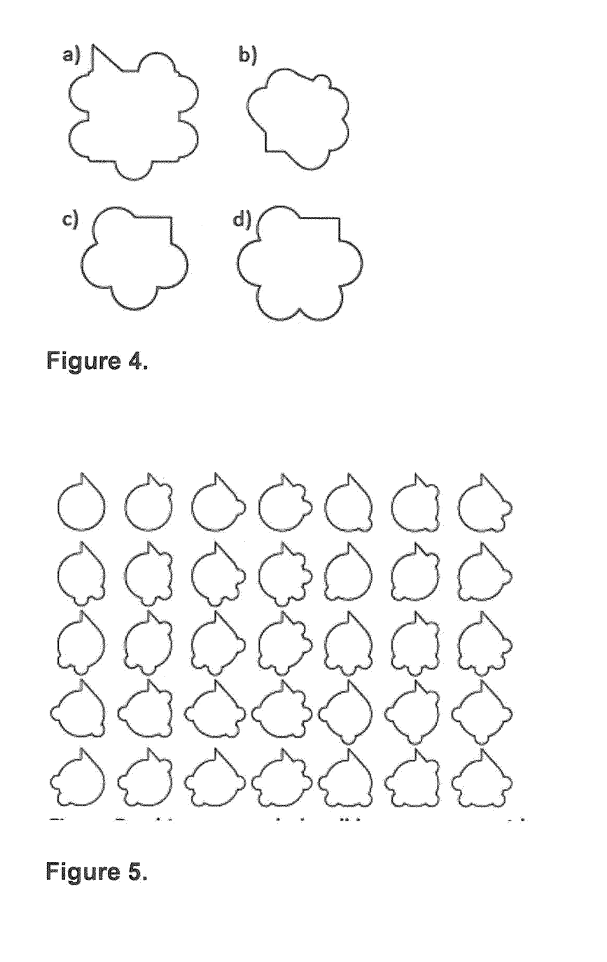

Different microwell designs were developed to enable correlative microscopy. After sectioning it would be very difficult to determine a well position if an ordered array of round wells were used (see FIG. 2a). Two ways were developed to overcome this problem, firstly, wells were designed to be different distances away from each other (see FIG. 3). When a section is taken, as long as there are at least three wells in a 2D arrangement, it is possible to calculate an individual well position (see FIG. 2b). The second method used bumps on the edge of the well to give the well its own code. Each well is now individual so its position can be easily calculated. There are three parts to this well type:
i. The well itself, a place for the cell to rest
ii. The code around the edge, this is a simple, for example, binary code where each well is numbered (e.g. 1001101 for say well 77 or 0011111 for say well 31)
iii. The final part is a marker such as a triangle denoting the order in which the code is read, this is important due to the possibility of a section being in any orientation after it has been sectioned and handled (see FIG. 5)

A similar system was devised where the shape of the well was an octagon with various edges missing or present, this also used a binary code (see FIG. 4). Whilst we used round extensions to denote the code, any shape can be used. Differences could also have been made to the code, if there are two different shapes at any one position a tertiary code could be used (e.g. 010221 would encode for well 106, [3⁰+2×3¹+2×3²+3⁴]) if there are three shapes a quaternary system can be used and so on. It may also be possible to encode for an 8×8 array using an 8-bit binary form of hexadecimal, in this case the array would be divided into two sections, the number and the letter e.g. 1a being 00011010 (0001 is binary for 1, 1010 is binary for a) and 7d being 01111101 (0111=7, 1101=d). The binary system was chosen as this is the simplest form.

Another important feature which could be used independently of the above or incorporated therein is a funnel shaped extension. This is where the relative size of the extrusion changes with depth, e.g. smaller at the bottom of the well and wider at the top of the well. Although more difficult to manufacture, this would provide a way of estimating the depth of the slice within the well.

### Chemical Modification

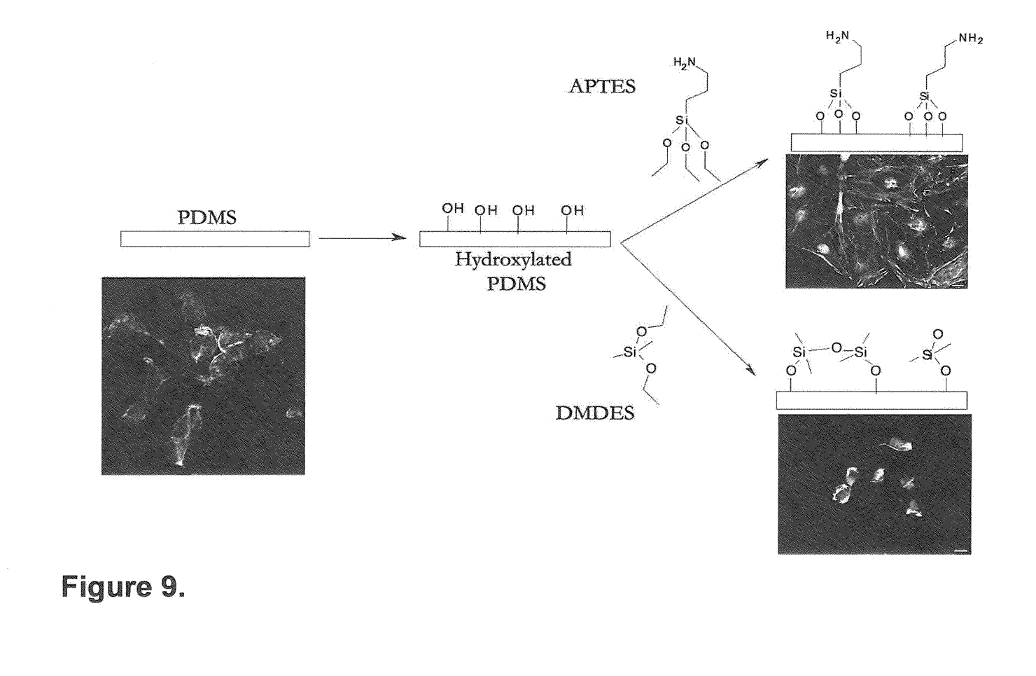

PDMS is a hydrophobic material and doesn't promote cell binding it is however, non-toxic and has been used in a variety of microfluidic-cell applications. By modifying the surface we were able to reduce cytophobicity of the surface. The PDMS surface has been shown, by various research groups, to be hydroxylated in a variety of ways using oxygen plasma etching, UV ozone or by chemical reaction. In most cases, however, the hydroxylated surface has shown to be short lived and requires further modification to keep the surface viable. We achieved this by using APTES (aminopropyltriethoxysilane, see FIG. 9), when the surface was modified using APTES there was improved cell-surface binding than with unmodified surface or DMDES modified surface.

### Grid Confocal Imaging

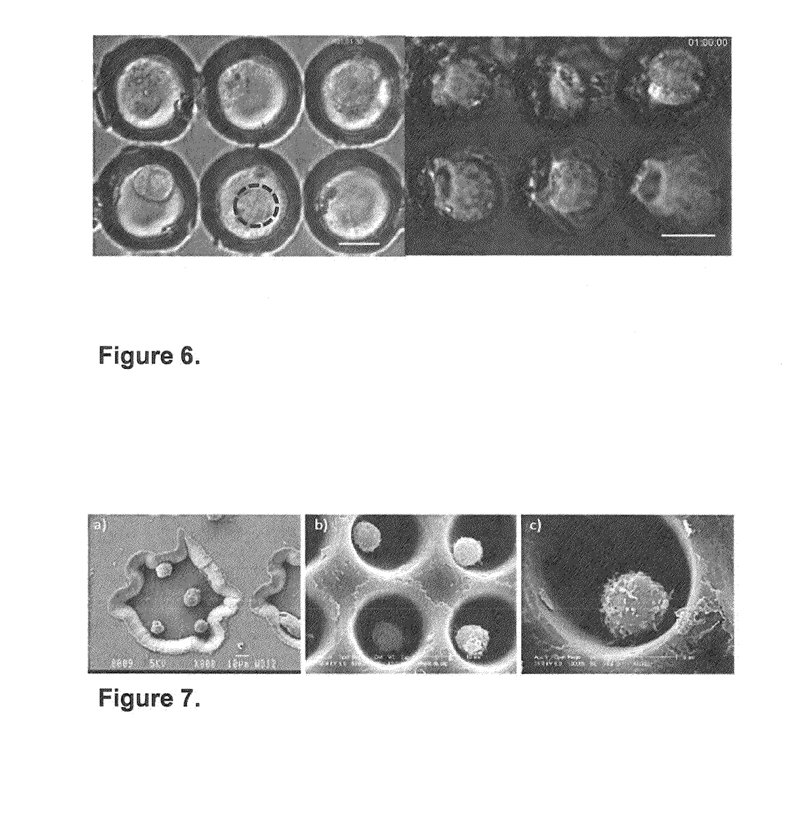

Live movies show KG1a cells residing in the grids after exposure to an apoptotic peptide. Cells uptake propidium iodide and it is possible to see blebbing occurring on the surface of the cells. This blebbing is not present during exposure to the control peptide (see FIG. 6).

### Cell SEM Imaging

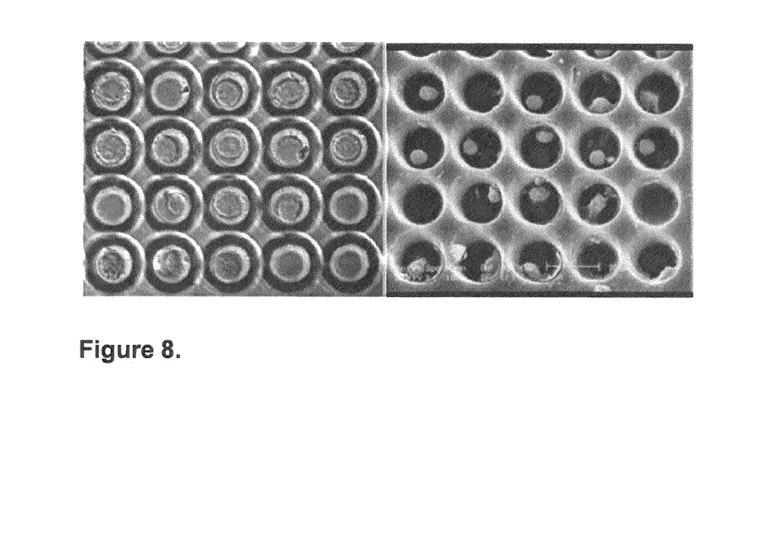

Cells have also been imaged using scanning electron microscopy. KG1a cells were again imaged under scanning electron microscopy in both round well arrays and coded arrays (see FIG. 7). Images show similar cell morphology between cells in the array and cells resting on the surface indicating the well don't have an effect on cell uptake. Correlative light-SEM images were also taken of KG1a cells resting in round wells. Localisation is consistent between the light images and SEM images to indicate the cells have not moved during the fixation and preparation process (see FIG. 8).

### Material Slicing

First attempts at slicing the epoxy resin 301-2 at the recommended ratio of 100:35 part A (diglycidyl ether of bisphenol A): part B (polyoxypopylenediamine) was not possible due to the strength of the material. Different ratios of the two parts of the epoxy were attempted to determine the most suitable material for cutting, aiming for the material to have similar properties to Araldite™. Most ratios still proved too strong for sectioning leaving two ratios 100:20 and 100:60 most effective. The final material is still rigid and strong but soft enough to allow sectioning with the glass knife at both 1 μm and 100 nm thicknesses.

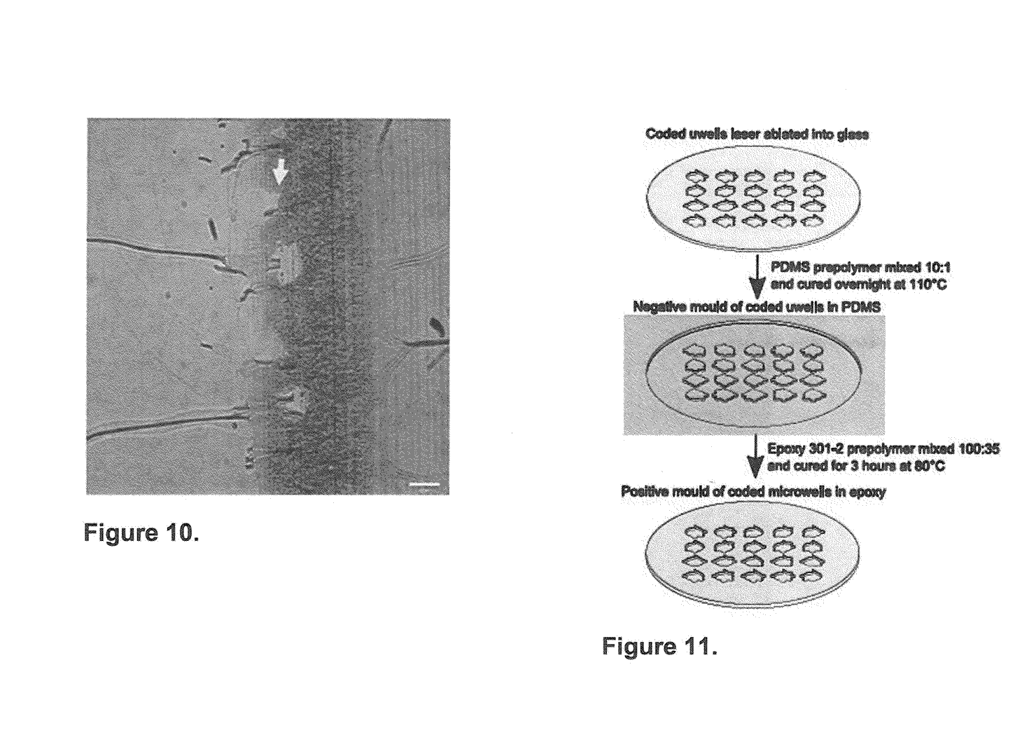

Whilst both 100:20 and 100:60 showed suitability it was decided to continue using 100:20 for sectioning the wells. A copy of the coded wells was made from the ablated glass using a PDMS intermediate, and backfilled using Araldite™. Sectioning of the Araldite™:301-2 epoxy block was much easier with sections of both Araldite™ and 301-2 possible. Sectioning through the wells also produced some success, however, the wells were at an angle to the blockface making it difficult to read the code produced (see FIG. 10).

TABLE 1

| | Imaging | Biological | | |
|---|---|---|---|---|
| | Method^{2 3} | Specimen | Visible unit | Alterations needed to microwell |
| Visible and | Epifluorescent | Cells/tissue | Fluorescent | Surface features visible under bright |
| UV Light | microscopy | | probes | field element |
| | Confocal | Cells/tissue | Fluorescent | Surface features visible under bright |
| | microscopy | | probes | field element |
| | Total internal | Cells/tissue | Fluorescent | Surface features visible under bright |
| | reflection | | probes | field element |
| | fluorescence | | | |
| | (TIRF) | | | |
| | microscopy | | | |
| | Stochastic | Cells/tissue | FRET | Surface features visible under bright |
| | optical | | (Forster | field element |
| | reconstruction | | radiation | |
| | microscopy | | emission | |
| | (STORM) | | transfer) of | |
| | | | fluorescent | |
| | | | probes | |
| | Two photon | Cells/tissue | Fluorescent | Surface features visible under bright |
| | fluorescence | | probes | field element |
| | microscopy (2- | | | |
| | Pi) | | | |
| | Stimulated | Cells/tissue | Fluorescent | Surface features visible under bright |
| | emission | | probes | field element |
| | depletion | | | |
| | microscopy | | | |
| | (STED) | | | |
| | Ellipsometry | Cells | Change in | Surface features visible |
| | | | polarisation | |
| | Digital | Cells | Holographic | Surface features visible |
| | holographic | | reconstruction | |
| | microscopy | | | |
| | Saturated | Cells/tissue | Fluorescent | Surface features visible under bright |
| | structured | | probes | field element |
| | illumination | | | |
| | microscopy | | | |
| | (SSIM) | | | |
| | Photo-activated | Cells | Fluorescent | Surface features visible under bright |
| | localization | | probes | field element |
| | microscopy | | | |
| | (PALM) | | | |
| | White light | Cells/ | Visible light | Surface features visible |
| | nanoscope¹ | bacteria/ | | |
| | | viruses | | |
| Electron | Scanning | Cells/tissue | Electron | Surface features visible |
| | electron | | scattering | |
| | microscopy | | | |
| | (SEM) | | | |
| | Transmission | Cells | Electron | Contrasting agent needed (uranyl |
| | electron | | transmission/ | acetate or other electron dense |
| | microscopy | | absorption | compound) |
| | (TEM) | | | |
| | Scanning | Cells/tissue | Electron | Contrasting agent needed (uranyl |
| | electron | | transmission/ | acetate or other electron dense |
| | tomography | | absorption | compound) |
| Physical | Atomic force | Cells/ | Physical | Surface features visible, wells must |
| | microscopy | bacteria/ | scanning of | be small and shallow |
| | (AFM) | viruses | surface | |
| | Scanning | Surfaces/ | Electrical | Surface needs to be electrically |
| | tunneling | membranes | conductance | conductive, electrical resistance |
| | microscopy | | | contrast may need to be used. |
| | (STM) | | | |
| Infra-red | Coherent anti- | Cells/lipids | Chemical | Contrasting agent (lipid or gold |
| | Stokes Raman | | bonds | coating) |
| | spectroscopy | | | |
| | (CARS) | | | |
| | Surface- | Cells | Chemical | Contrasting agent (nanoparticle, |
| | enhanced Raman | | bonds | carbon nano-tube or graphene |
| | spectroscopy | | | coating) |
| | (SERS) | | | |
| | Fourier- | Cells | Chemical | Contrast agent with unique chemical |
| | transform | | bond | signature |
| | infrared (FTIR) | | | |
| | microscopy | | | |
| | Scanning near- | Cells | Phase | Contrasting agent with unique |
| | field optical | | contrast and | chemical signature |
| | microscopy | | chemical | |
| | (SNOM) | | bond | |
| X-ray | X-ray phase | Cells | Carbon - | Contrasting agent needed |
| | contrast | | oxygen | |
| | | | contrast | |
| | X-ray | Cells | Fluorescence | Contrasting agent needed (heavy |
| | fluorescence | | of heavy | metals) |
| | microscopy | | metals | |
| | Particle induced | Cells | Fluorescence | Contrasting agent needed (metals) |
| | x-ray emission | | of elements | |
| | (PIXE) | | heavier than | |
| | | | fluorine | |
| Ion | Secondary ion | Cells | Particle | Contrasting agent needed |
| | mass | | scatter from | |
| | spectrometry | | ion beam | |
| | microscopy | | | |
| | (μSIMS) | | | |

¹Wang, Z., et al. Optical virtual imaging at 50 nm lateral resolution with a white-light nanoscope. Nat Commun 2, 218 (2011).
²Petibois, C. Imaging methods for elemental, chemical, molecular, and morphological analyses of single cells. Analytical and Bioanalytical Chemistry 397, 2051-2065 (2010).
³Bullen, A. Microscopic imaging techniques for drug discovery. Nature Reviews Drug Discovery 7, 54-67 (2008).

### CONCLUSION

It can therefore be seen that we have developed a highly useful way of correlating data obtained on cellular images using a variety of imaging techniques. Our methodology involves the manufacture of unique multiwall arrays wherein the individual shape of each well within the array is different from any other well within the array and this difference is used as a way of naming and so identifying each well within the array.
1. Fernandez-Suarez, M. and A. Y. Ting, Fluorescent probes for super-resolution imaging in living cells. Nat Rev Mol Cell Biol, 2008. 9(12): p. 929-43.
2. Huang, B., et al., Three-dimensional super-resolution imaging by stochastic optical reconstruction microscopy. Science, 2008. 319(5864): p. 810-3.
3. Giepmans, B. N., Bridging fluorescence microscopy and electron microscopy. Histochem Cell Biol, 2008. 130(2): p. 211-7.
4. Luo, C. X., et al., The combination of optical tweezers and microwell array for cells physical manipulation and localization in microfluidic device. Biomedical Microdevices, 2007. 9(4): p. 573-578.
5. Mittal, N., A. Rosenthal, and J. Voldman, NDEP microwells for single-cell patterning in physiological media. Lab on a Chip, 2007. 7(9): p. 1146-1153.
6. Nalayanda, D. D., M. Kalukanimuttam, and D. W. Schmidtke, Micropatterned surfaces for controlling cell adhesion and rolling under flow. Biomedical Microdevices, 2007. 9(2): p. 207-214.
7. El-Ali, J., P. K. Sorger, and K. F. Jensen, Cells on chips. Nature, 2006. 442(7101): p. 403-411.
8. Tokilmitsu, Y., et al., Single lymphocyte analysis with a microwell array chip. Cytometry Part A, 2007. 71A(12): p. 1003-1010.
9. Ochsner, M., et al., Micro-well arrays for 3D shape control and high resolution analysis of single cells. Lab on a Chip, 2007. 7(8): p. 1074-1077.
10. McDonald, J. C., et al., Fabrication of microfluidic systems in poly(dimethylsiloxane). Electrophoresis, 2000. 21(1): p. 27-40.
11. Verkade, P., Moving EM: the Rapid Transfer System as a new tool for correlative light and electron microscopy and high throughput for high-pressure freezing. J Microsc, 2008. 230(Pt 2): p. 317-28.

1. A multiwell array comprising a plurality of wells wherein each well comprises:
(a) a unique cross-sectional shape comprising at least one projection and/or indentation; and
(b) a universal projection or indentation in the same position on each well so as to indicate a standard orientation or reference point for taking a reading of the number, nature and position of each projection and/or indentation on a selected well as one works about the well.

2. The multiwell array according to claim 1 wherein each well is provided with a unique non-random cross-sectional shape.

3. The multiwell array according to claim 2 wherein said unique non-random cross-sectional shape is provided along a substantial part of the depth or height of the well.

4. The multiwell array according to claim 3 wherein said unique non-random cross-sectional shape is provided along the entire depth or height of the well.

5. The multiwell array according to claim 1 wherein each well is provided with said unique cross-sectional shape having regard to the alignment of each well with respect to a selected axis, so that wells of the same cross-sectional shape may be rotated with respect to said axis so as to provide different shapes when viewed from a fixed point.

6. The multiwell array according to claim 1 wherein each well is provided with a common cell accomodating region from which at least one projection protrudes and/or into which at least one indentation indents to thus give each well its unique crossectional shape.

7. The multiwell array according to claim 1 wherein each well comprises a plurality of projections and/or indentations.

8. The multiwell array according to claim 6 wherein the shape and/or position of said projection(s) and/or indentation(s) with respect to the common cell accomodating region is different between different wells.

9. The multiwell array according to claim 6 wherein the common cell accomodating region is generally of round or square section.

10. The multiwell array according to claim 6 wherein the projections or indentations are either curved so that they appear as a bump or angular so that they appear as a pointed projection.

11. The multiwell array according to claim 6 wherein the common cell accomodating region comprises an internal chamber, which is fixed within the well or removable therefrom.

12. The multiwell array according to claim 11 wherein said internal chamber is of the same shape and/or size between wells.

13. The multiwell array according to claim 11 wherein said internal chamber is of different size.

14. The multiwell array according to claim 1 wherein the universal projection or indentation is a projection or indentation of the same size and shape between wells.

15. The multiwell array according to claim 1 wherein at least one of said projections or indentations decreases in size along the depth or height of the well.

16. The multiwell array according to claim 1 wherein the spacing or distance between selected, or each, well(s) within the array with respect to the position of other adjacent wells, or wells along the same axis, is different.

17. The multiwell array according to claim 1 wherein the array is made from a synthetic plastics.

18. The multiwell array according to claim 17 wherein the synthetic plastics is suitable for being sectioned for microscopy.

19. The multiwell array according to claim 18, wherein the synthetic plastics material comprises a polydimethyl siloxane (PDMS) elastomer and/or an epoxy resin.

20. The multiwell array according to claim 19, wherein the PDMS is modified to create surface hydroxyl groups.

21. The multiwell array according to claim 19, wherein the epoxy resin provides a ratio of about 100:60 diglycidyl ether of Bisphenol A:polyoxypropylenediamine.

22. The multiwall array according to claim 19 wherein the epoxy resin provides a ratio of about 100:20 diglycidyl ether of Bisphenol A:polyoxypropylenediamine.

23. A method for the identification of wells within a multiwell array according to claim 1 comprising:
a) selecting a point from which to begin reading the outer cross-sectional shape of each well within said array by identifying a location of a universal indicator common to all the wells;
b) designating each projection or indentation with a unique identifier, having regard to its size and shape, as a reading is taken from said selected point about the edge of each well;
c) designating each space between projections and/or indentations with an identifier as a reading is taken about the edge of each well; and
d) using the nature, order and number of said universal indicator location, said projection or indentation unique identifier, and said identifier of each said space between projections and/or indentations as a reading is taken about the edge of each well to provide each well with a unique identification code that enables each well to be identified within an array and tracked thereafter.

24. The method according to claim 23 wherein said space between projections and/or indentations is also provided with a unique identifier having regard to its size and/or position from said selected point.

25. An apparatus for identifying wells within a multiwell array according to the method of claim 19, comprising an imaging apparatus operatively connected to at least one processor and at least one memory storing executable instructions that, when executed, cause the apparatus to:
a) select a point from which to begin reading the outer cross-sectional shape of each well within said array by identifying the location of a universal indicator common to all the wells and storing said universal indicator location;
b) designate each projection or indentation with a unique identifier, having regard to its size and shape, as a reading is taken from said selected point about the edge of each well and storing said projection or indentation unique identifier;
c) designate each space between projections and/or indentations with an identifier as a reading is taken about the edge of each well and storing said identifier of said each space between projections and/or indentations; and
d) using the nature, order and number of said universal indicator location, said projection or indentation unique identifier, and said identifier of each said space between projections and/or indentations as a reading is taken about the edge of each well to provide each well with a unique identification code that enables each well to be identified within an array and tracked thereafter; and
e) storing said each well unique identification code.

26. The apparatus of claim 25, further wherein the at least one memory stores executable instructions that, when executed, cause the apparatus to provide said each space between projections and/or indentations with a unique identifier having regard to its size and/or position from said selected point.

27. The apparatus of claim 25, wherein the imaging apparatus is a microscope.
